(19) United States
(12) Patent Application Publication
(10) Pub. No.: US 2005/0274031 A1
(43) Pub. Date: Dec. 15, 2005

(54) Surveying apparatus

(75) Inventors: Masaaki Imamura, Tokyo (JP); Yoshihiro Motoki, Tokyo (JP); Yoshikatsu Miyao, Tokyo (JP)

Correspondence Address: Robert J. Schneider;Chapman and Cutler LLP, 16th Floor, 111 West Monroe Street, Chicago, IL, 60603-4080, US

(73) Assignee: Kabushiki Kaisha TOPCON, Tokyo (JP)

(21) Appl. No.: 11/146,666

(22) Filed: Jun. 7, 2005

(30) Foreign Application Priority Data
Jun. 14, 2004 (JP) 2004-175192

(51) Int. Cl. G01C 5/00

(52) U.S. Cl. 33/290

(57) ABSTRACT

A surveying apparatus includes a display portion capable of displaying a display form, a storing portion for storing the display form, and a display control device configured to display the display form stored in the storing portion onto the display portion, and the display control device previously displays the display form stored in the storing portion onto the display portion in conjunction with an activation of the surveying apparatus, and changes to a surveyable state after a predetermined time has passed since the display form was displayed.

### BACKGROUND OF THE INVENTION

1. Field of the Invention

The present invention relates to a surveying apparatus capable of contributing to prevention of theft and loss, and confirmation of a missing article.

2. Related Art Statement

Recently, with progress of computerized surveying apparatus, there has been developed a surveying apparatus incorporated electronic information for displaying maintenance information, etc., onto a display portion in order to inform a maintenance timing (for example, Japanese Patent Laid-Open 2002-365052).

A surveying apparatus is utilized by professionals and major civil engineering companies, and is very valuable. Accordingly the surveying apparatus was not familiar with the general, and it was rare that the surveying apparatus was robbed from a field operation. However, recently, the surveying apparatus has been widely used in the general, so that the surveying apparatus has an increasing number of risks of being robbed.

Especially, a recent surveying apparatus has been further computerized, and has been provided with a surveying program incorporated a surveying step in addition to an angle measuring function and a ranging function to have a high accuracy and to be further conveniently utilized. Accordingly, the surveying apparatus becomes further valuable, so that a financial loss is large when the surveying apparatus is rubbed

Moreover, in a large-scale joint construction, many of contractors are participated in a surveying operation to perform a construction, so that there may be a case that they bring a surveying apparatus having the same performance and a surveying apparatus having a similar performance. Therefore, there is a problem that it takes a long time to confirm whether the surveying apparatus is own surveying apparatus or not when the surveying apparatus is lost by not only being robbed but also being mixed into the surveying apparatus of other contractors by an insufficient management.

In the related art, a management for previously listing a manufacturing number, production number, etc., stamped, carved and printed in a surveying apparatus in a management book is conducted. However, there may be a case to forget listing these numbers in the management book. In addition, there may be an inconvenience that it is hard to confirm these numbers when the manufacturing number, production number, etc., are hard to read.

### SUMMARY OF THE INVENTION

The present invention has been made in view of the above problems, and an object of the present invention is to provide a surveying apparatus capable of contributing to prevention of theft and loss, and confirmation of a missing article.

According to one embodiment of the present invention, a surveying apparatus comprises a display portion capable of displaying a display form, a storing portion for storing the display form, and a display control device configured to display the display form stored in the storing portion onto the display portion, wherein the display control device previously displays the display form stored in the storing portion onto the display portion in conjunction with an activation of the surveying apparatus, and changes to a surveyable state after a predetermined time has passed since the display form was displayed.

In the surveying apparatus of one embodiment of the present invention, the display control device displays the display form onto the display portion by an operation of a pausing switch for stopping a surveying operation.

In the surveying apparatus of one embodiment of the present invention, the display form comprises an indication to remind of a person in charge, user or owner.

In the surveying apparatus of one embodiment of the present invention, the display form comprises an image to remind of a person in charge, user or owner.

According to the surveying apparatus in one embodiment of the present invention, a specific display form stored in the storing portion is displayed in conjunction with the operation of the switch, so that the loosing of the surveying apparatus can be prevented, and the confirmation of the missing article can be conducted by confirming the specific display form when loosing the surveying apparatus.

According to the surveying apparatus in one embodiment of the present invention, the theft and loss of the surveying apparatus can be more absolutely prevented, and the missing article can be more absolutely confirmed.

According to the surveying apparatus in one embodiment of the present invention, the surveying apparatus can be more easily specified.

### PRIORITY CLAIM

This application claims the benefit of priority to Japanese Application No. 2004-175192 filed on Jun. 14, 2004, which is hereby incorporated by reference.

### BRIEF DESCRIPTIONS OF THE DRAWINGS

FIG. 1 is a perspective view illustrating one example of a surveying machine.

FIG. 2 is a block circuit diagram of the surveying machine according to one embodiment of the present invention.

FIG. 3A is an explanation view of specific display forms displayed onto a display portion of one embodiment of the present invention, and showing a state that a logo displaying a symbol of a manufacturing company is displayed.

FIG. 3B is an explanation view of specific display forms displayed onto a display portion of one embodiment of the present invention, and showing a state that a logo displaying a symbol of a sales company is displayed.

FIG. 3C is an explanation view of specific display forms displayed onto a display portion of one embodiment of the present invention, and showing a state that a logo displaying a symbol of a company's name of purchaser is displayed.

FIG. 3D is an explanation view of specific display forms displayed onto a display portion of one embodiment of the present invention, and showing a state that a facial portrait image of a person in charge is displayed as a specific display form.

FIG. 4 is a flow chart for explaining a function of a surveying apparatus according to one embodiment of the present invention.

### DETAILED DESCRIPTION OF THE PREFERRED EMBODIMENT

Hereinafter, an embodiment of a surveying apparatus according to the present invention will be explained with reference to the accompanying drawings.

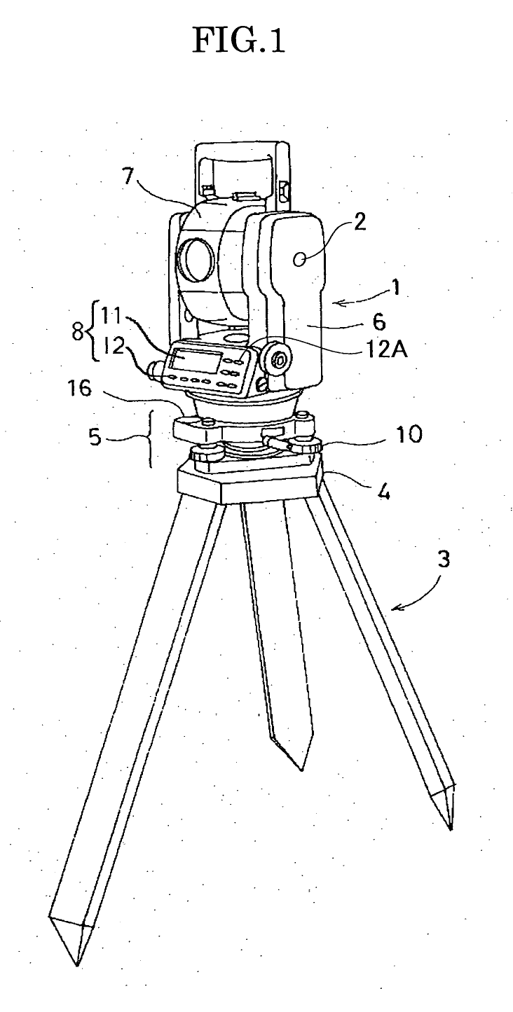

As shown in FIG. 1, a surveying machine 1 is provided on a head portion 4 of a tripod stand 3. The surveying machine 1 comprises a base portion 5 having a leveling function, a mounting portion 6 disposed in the base portion 5 to be rotatable about the center of the vertical axis and a telescope portion 7 disposed in the mounting portion 6 to be rotatable about the center of the horizontal axis.

When the surveying machine 1 is installed, a leveling screw 10 provided on the base portion 5 is turned to adjust the position of the base portion 5 such that a bubble of a circular bubble tube 16 provided on the base portion 5 is positioned in the center.

An operation portion 8 is provided in the lower portion of the mounting portion 6, and a switch 2 is provided in the side portion of the mounting portion 6 as a main switch for driving the surveying machine 1. The operation portion 8 comprises a display portion 11 and an operation input portion 12 having the required number of pressing buttons. In the operation portion 8, an operation surface and a displaying surface are turned upward to be easily seen by a worker.

The surveying machine 1 is structured to be carried by a user, and is manufactured to be small and light. Accordingly, the operation portion 8 is arranged in a limited space, and the operation portion 8 has a reduced space structure. Moreover, in the operation input portion 12, the functions of button are switched by a function key, and a plurality of operations can be performed by one key in order to reduce the number of pressing buttons. The operation input portion 12 is provided with a pausing switch 12A as a pausing switch for stopping a surveying operation.

A screen of the display portion 11 can be switched by a content of display in order to effectively display the display of the display portion 11 with a small area. More particularly, the displays such as setting of selected mode and remaining of a battery are conducted onto the display portion in addition to the displays such as a surveying result, angle measuring value and measuring value of the surveying machine 1 by switching the display screen.

The surveying machine 1 comprises a movable portion, a mechanical portion having a driving portion, an electronic circuit portion conducting power supply, and the like. The mechanical portion comprises a mechanical module, and the electronic portion comprises an electronic circuit module.

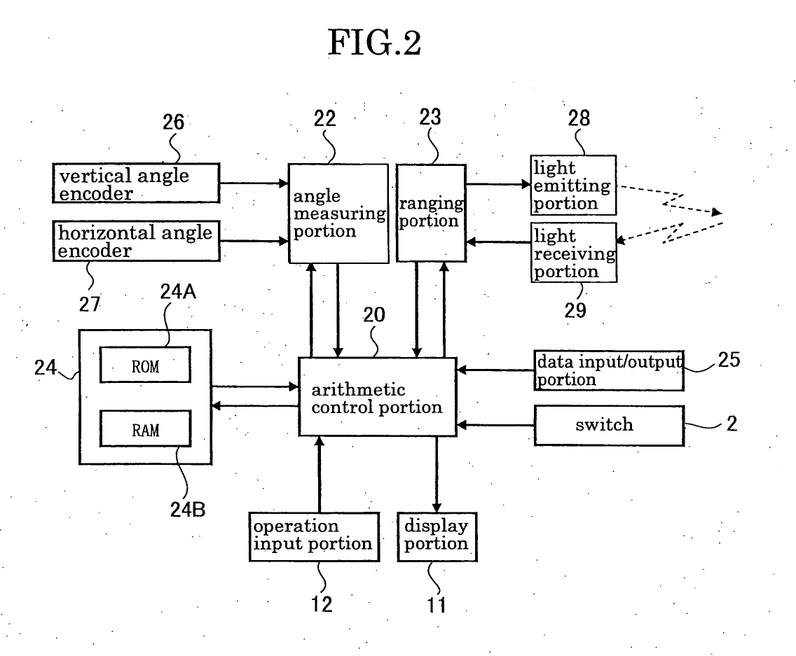

FIG. 2 is a block diagram illustrating a module structure of the surveying machine 1. In FIG. 2, a reference numeral 20 denotes an arithmetic control portion, 22 denotes an angle measuring portion, 23 denotes a ranging portion, 24 denotes a storing portion and 25 denotes a data input/output portion.

The arithmetic control portion 20 includes a function for switching the display portion 11 to a surveying screen display mode and to a display form display screen mode, and makes a surveying operation to be an executable state in the surveying screen display mode.

In the surveying screen display mode, the arithmetic control portion 20 outputs a command for measuring an angle to the angle measuring portion 22, pulse outputs are input from a vertical angle encoder 26 and a and a horizontal angle encoder 27 to the angle measuring portion 22, and the angle measuring portion 22 calculates the horizontal angle and vertical angle by counting the pulse outputs. The angle measuring portion 22 outputs the positioning result to the arithmetic control portion 20.

The arithmetic control portion 20 similarly outputs a command for measuring a distance to the ranging portion 23, the ranging portion 23 controls the emission of a light emitting portion 28, irradiates a measuring light toward a measured object, and receives the reflection light from the measured object by a light receiving portion 29, and then the ranging portion 23 measures a distance to the measured object based on the light receiving result. The ranging portion 23 outputs the ranging result to the arithmetic control portion 20.

The storing portion 24 comprises a read only memory, ROM 24A and a readable and writable memory RAM 24B, for example. A program such as a surveying program is stored in the ROM 24A, for example. The arithmetic control portion 20 reads a necessary program from the ROM 24A based on the operation from the operation input portion 12, and conducts a process in accordance with the operation. Data for displaying a display form onto the display portion 11 is incorporated into the RAM 24B, but the details of the data will hereinafter be described.

The display portion 11 displays a perpendicular angle, horizontal angle, distance to the measured object, etc., on the screen in accordance with the surveying operation as described above.

The data input/output portion 25 is used for inputting data related to an after-mentioned display form to the arithmetic control portion 20.

The arithmetic control portion 20 includes a function as a display control device. The display control device previously displays a specific display form stored in the storing portion 24 onto the display portion 11 in conjunction with the operation of the switch 2, and changes to a surveyable state after a predetermined time has passed since the display form was displayed.

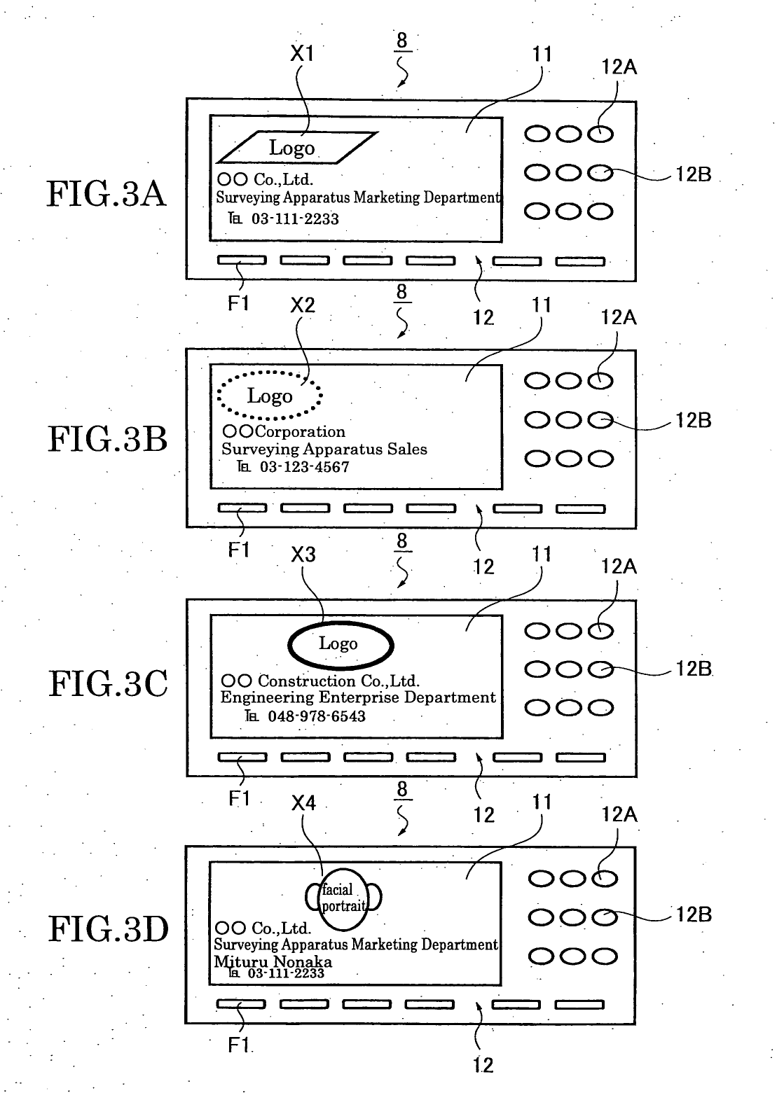

In this case, the specific display form means a logo X1 displaying a symbol of manufacturing company illustrated in FIG. 3A, a logo displaying a symbol of sales company illustrated in FIG. 3B, a logo X3 displaying a symbol of company's name of purchaser illustrated in FIG. 3C, or the like. If necessary, the specific display form includes characters such as a department's name, telephone number and the like. In addition, this display form may be an indicator or image to remind of a person in charge, user or owner.

If these specific display forms are incorporated, it is convenience to confirm the surveying apparatus when the surveying apparatus is lost or robbed. Moreover, the display forms are display forms specific to the user and owner of the surveying apparatus, so that the specific display forms are effective for prevention of theft.

In addition, for example, Windows (registered trade mark) is used for an operation program (OS) regarding to the image display function.

The data related to the display form is input to the arithmetic control portion 20 through the data input/output portion 25. The input of the data is performed by using an ID and password for preventing the data related to the display form from erasing as a security measure (security lock). The input of the ID and password is carried out by displaying a password input screen on the display portion 11 by means of the combination between a function key F1 and pressing button 12B.

The arithmetic control portion 20 outputs the data related to the display form to the RAM 24B, and the information related to the display form is stored in the RAM 24B.

Image data corresponding to a facial portrait image of a person in charge is stored in the RAM 24B, and this facial portrait image is input to the arithmetic control portion 20 through the data input/output portion 25. In this case, the arithmetic control portion 20 has a function for displaying the facial portrait image of a person in charge on the display portion 11 as illustrated in FIG. 3D by stopping the execution of the surveying operation mode when the pausing switch 12A is operated.

The information related to the display forms illustrated in FIGS. 3A to 3D can be sequentially rewritten from the information related to the display forms illustrated in FIG. 3A to the information related to the display forms illustrated in FIG. 3D by overwriting in a predetermined area of the RAM 24B. The information related to the display forms illustrated in FIGS. 3A to 3D can be newly written in another area, and can be stored in a separate storing area, respectively.

Hereinafter, it will be explained that the information related to the display forms illustrated in FIG. 3C and the information related to the display forms illustrated in FIG. 3D are stored in the RAM 24B as the information related to the display forms after the surveying apparatus has been sold to a customer.

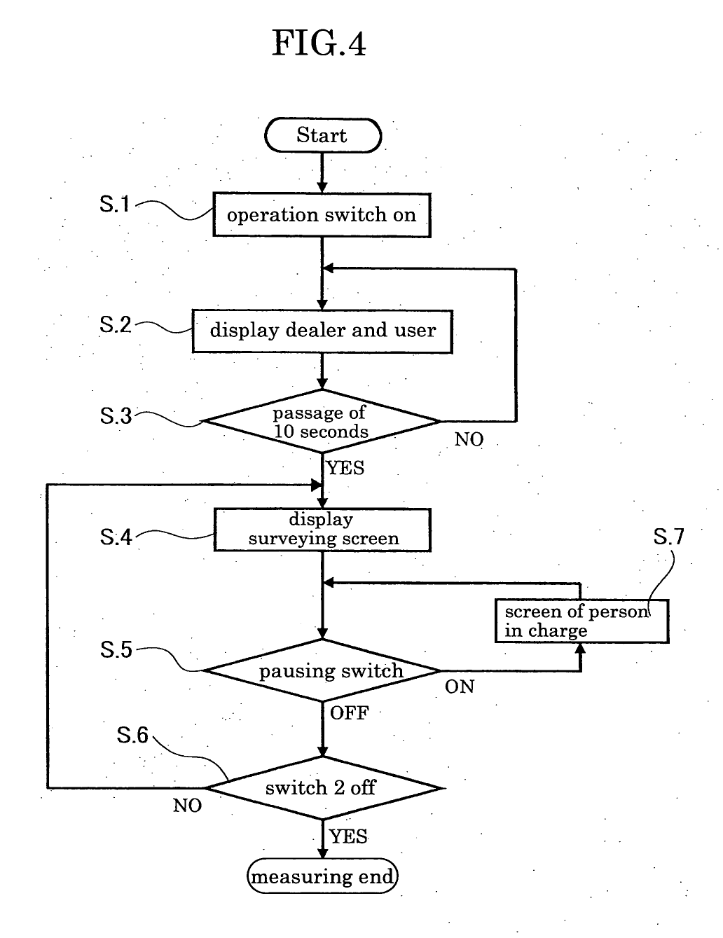

As illustrated in FIG. 4, when turning on the switch 2 (S.1), the logo such as the dealer, user, etc., company's name, department, telephone number and the like are displayed by the arithmetic control portion 20 (S.2) as shown in FIG. 3C. Next, the arithmetic control portion 20 waits until a predetermined time passes (S.3).

Accordingly, after the operation of the switch 2, the display of the display forms such as the logo, company's name, department, and telephone number is maintained on the display portion 11 until a predetermined time passes.

The arithmetic control portion 20 becomes the surveying screen display mode after a predetermined time has passed to change the surveying machine 1 to be the surveyable state. Accordingly, the surveying screen is displayed on the display portion 11 (S.4). The surveying can be performed with a state that this surveying screen is displayed.

Next, the arithmetic control portion 20 determines whether or not the pausing switch 12A is turned on (S.5). When the pausing switch 12A is the off state, the arithmetic control portion 20 determines whether or not the switch 2 is turned off (S.6). When the switch 2 is the on state, the arithmetic control portion 20 goes back to the step S.4, and the display of surveying operation screen is continued on the display portion 11.

When the pausing switch 12A is turned on, the arithmetic control portion 20 displays the image of a person in charge on the display portion 11 (S.7), and goes back to the step S.5. The arithmetic control portion 20 maintains the display state of the image of the person in charge until the pausing switch 12A is turned off.

In other words, the arithmetic control portion 20 functions as a display control device to previously display the specific display form stored in the storing portion 24 onto the display portion 11 in conjunction with the operation of the switch 2, and to change to the surveyable state after a predetermined time has passed since the display form was displayed.

When the pausing switch 12A is turned off, the arithmetic control portion 20 determines whether the switch 2 is the on state or the off state (S.6). When the switch 2 is the on state, the arithmetic control portion 20 goes back to the step S.4, and displays the surveying screen, and when the switch 2 is the off state, the arithmetic control portion 20 completes the surveying operation.

1. A surveying apparatus, comprising:
a display portion capable of displaying a display form;
a storing portion for storing the display form; and
a display control device configured to display the display form stored in the storing portion onto the display portion, wherein
the display control device previously displays the display form stored in the storing portion onto the display portion in conjunction with an activation of the surveying apparatus, and changes to a surveyable state after a predetermined time has passed since the display form was displayed.

2. The surveying apparatus according to claim 1, wherein the display control device displays the display form onto the display portion by an operation of a pausing switch for stopping a surveying operation.

3. The surveying apparatus according to claim 1, wherein the display form comprises an indication to remind of a person in charge, user or owner.

4. The surveying apparatus according to claim 2, wherein the display form comprises an image to remind of a person in charge, user or owner.
